(19) United States
(12) Patent Application Publication
(10) Pub. No.: US 2017/0337499 A1
(43) Pub. Date: Nov. 23, 2017

(54) BALANCING ASSIGNMENT OF ALERTS ACROSS ENDPOINTS

(71) Applicant: International Business Machines Corporation, Armonk, NY (US)

(72) Inventors: Helmut Baumgartner, Nuertingen (DE); Monika Illgner-Kurz, Herrenberg (DE); Denilson Nastacio, Apex, NC (US); Vadim Raskin, Boeblingen (DE)

(21) Appl. No.: 15/161,673

(22) Filed: May 23, 2016

(51) Int. Cl. G06Q 10/06

(52) U.S. Cl. CPC G06Q 10/063112

(57) ABSTRACT

A method and system for dynamically assigning alerts to endpoints. Topic dependent technical skill points are individually assigned to each endpoint of at least two endpoints. An alert is received for a task relating to a selected topic. In response to receiving the alert, (i) the received alert is assigned to an assignment endpoint having a highest number of available technical skill points for the selected topic, wherein the assignment endpoint is a member of a first group of endpoints relating to the selected topic, (ii) available technical skill points of the assignment endpoint are deceased to a predefined value, and (iii) the available technical skill points for the assignment endpoint is increased gradually over an alert resolution time from the predefined value to a number of technical skill points identical to a lowest number of technical skill points of endpoints of any member of the first group of endpoints.

### TECHNICAL FIELD

The invention relates generally to improving human resources technology, and more specifically, to improving an efficiency of completing a task and a quality of a result from completion of the task, by dynamically assigning alerts to endpoints.

### BACKGROUND

Scheduling resources to requests has been a challenge to operators and those responsible for scheduling scarce or expensive resources to requestors. Typically, resources are scheduled upfront based on a static approach. Many scheduling techniques perform the assignment of potential requests before actual requests are available, thereby assuming a typical or average amount and sequence of requests. However, if an unpredictable amount of different requests at unpredictable times are the norm of a business or technical environment, the static approaches fail. This is often the case in alerting systems. An alert is typically assigned to an endpoint, which may represent an operator being qualified to resolve the alert related issue based on a static assignment algorithm. In case several endpoints (i.e., a group of endpoints) may be available and being able to resolve the issue, a person such as a scheduling operator may be required to perform the actual assignment of an incoming alert to an individual service person. Thus, there is no intelligent routing to an appropriate endpoint that has the best skills to handle a specific alert or a specific endpoint from a group of endpoints. All dispatching has to be done manually by a human resource; e.g., a scheduling operator, which may be a time consuming, stressful, unproductive and expensive approach and may not represent the best possible approach for assigning resources to requests (i.e., endpoints or operators to alerts) because at a given point in time there may only be one endpoint or operator defined to receive the alerts.

### SUMMARY

The present invention provides a method, and associated computer system and computer program product, for dynamically assigning alerts to endpoints. One or more processors of a computer system assign individually topic dependent technical skill points to each endpoint of a plurality of endpoints. The one or more processors receive an alert for a task relating to a selected topic. In response to the receiving of the alert, (i) the one or more processors assign the received alert to an assignment endpoint having a highest number of available technical skill points for the selected topic, wherein the assignment endpoint is a member of a first group of endpoints relating to the selected topic, and wherein the plurality of endpoints comprises the first group of endpoints, (ii) the one or more processors decrease available technical skill points of the assignment endpoint to a predefined value, and (iii) the one or more processors increase the available technical skill points for the assignment endpoint gradually over an alert resolution time from the predefined value to a number of technical skill points identical to a lowest number of technical skill points of endpoints of any member of the first group of endpoints.

### BRIEF DESCRIPTION OF THE DRAWINGS

It should be noted that embodiments of the invention are described with reference to different subject-matters. In particular, some embodiments are described with reference to method type claims whereas other embodiments have been described with reference to apparatus type claims. However, a person skilled in the art will gather from the above and the following description that, unless otherwise notified, in addition to any combination of features belonging to one type of subject-matter, also any combination between features relating to different subject-matters, in particular, between features of the method type claims, and features of the apparatus type claims, is considered as to be disclosed within this document.

The aspects defined above and further aspects of the present invention are apparent from the examples of embodiments to be described hereinafter and are explained with reference to the examples of embodiments, but to which the invention is not limited.

Embodiments of the invention will be described, by way of example only, and with reference to the following drawings.

FIG. 1 shows a block diagram of a method for dynamically assigning alerts to endpoints, in accordance with embodiments of the present invention.

FIGS, 2a, 2b, 2c, and 2d show block diagrams of a development of available technical skill points over time with two endpoints, in accordance with embodiments of the present invention.

FIGS. 3a, 3b, 3c, and 3d show block diagrams of a development of available technical skill points over time with more endpoints and more complex dependencies, in accordance with embodiments of the present invention.

FIG. 4 shows a shift overlap period and increasing and decreasing available technical skill points of a leaving shift and a beginning shift, respectively, in accordance with embodiments of the present invention.

FIG. 5 shows an embodiment of a state diagram of a group of endpoints in a shift, in accordance with embodiments of the present invention.

FIG. 6 shows a system for dynamically assigning alerts to endpoints, in accordance with embodiments of the present invention.

FIG. 7 shows a computing system for dynamically assigning alerts to endpoints, in accordance with embodiments of the present invention.

### DETAILED DESCRIPTION

In the context of this description, definitions of the following terms, with accompanying examples, are next presented.

The term ‘alert’ denotes a task to be performed; e.g., a problem that needs attention by an operator, a member of a service staff, or a service technician. Traditionally, alerts may, e.g., be received by a help desk or scheduling desk and a forwarding to a person dealing with the request or a related scheduling may be performed by a help desk operator. Typically, such scheduling rules are static based on the experience of the help desk operator.

The term ‘an alert is closed’ denotes that performance of the task associated with alert has been completed.

The term ‘dynamically assigning alerts’ denotes that alerts may be assigned dynamically and automatically; e.g., without an involved help desk operator. Moreover, the alerts or related task or problems to be solved are assigned to an operator. Additionally, the assigning is performed dynamically based on available operators and according to rules and policies which reflect dynamically an availability of operators and/or the operators' workload.

The term ‘endpoint’ denotes a device configured to receive an alert. The device may, e.g., be a personal computer, a tablet computer, a smartphone, a pager or any other device suitable for an electronic interaction with an operator. Typically, there may be a 1-to-1 relationship between an operator and a related device.

The term ‘topic dependent technical skill points’ denotes a qualification index for an operator expressed in technical skill points (TSP). Technical skill points may be topic or theme dependent. An operator may have skills in databases as well as in a specific software application. However, the operator's skills are not necessarily identical in different technical topics or technical fields. Each operator may have a set of technical skill points for different technical subjects.

The term ‘individual operator profile’ denotes a profile comprising operator specific characteristics; e.g., an identifier, a name, topics, technical fields and related technical skill points.

The term ‘selected topic’ denotes a technical topic that is related to a specific alert. Each alert may be classified into different categories, one of the categories being the technical topic.

The term ‘available technical skill points’ denotes dynamically changing technical skill points; i.e., the available technical skill points are those technical skill points for a selected topic an operator may have at a given point in time. Available technical skill points may vary over time. Once an alert may be assigned to an operator, the operator cannot work on the alert in parallel on another alert. Thus, the operator's available technical skill points may be reduced to, e.g., zero. However, the available technical skill points may also be increased over time again. In the simplest case, if there are no additional alerts waiting for assigning and resolution, the available technical skill points for an operator for a topic may be increased to the number of technical skill points from the operator's profile. Other increasing algorithms are possible, as explained infra.

The term ‘first group’ denotes a group of operators working together as a team for a specific topic during one shift. A shift may last for e.g. 8 or 9 hours; however, other duration times of a shift are possible. Hence, a second group may denote a group of operators working in a subsequent shift, during which the first group may be active.

The term ‘the assignment time’ denotes a point in time at which an alert is or may be assigned to an operator.

The term ‘alert resolution time’ denotes a time assumed to be sufficient for working on an alert and resolving a problem related to the alert. Typically, an alert is closed within the ‘alert resolution time.

The term ‘overlap time period’ denotes a time period during which the worktime or shift time of a first group and the worktime or shift time of a second group overlap.

The inventive method for dynamically assigning alerts to endpoints may offer multiple advantages and technical effects.

The inventive method and system overcomes the static scheduling approach of traditional scheduling methods for incoming requests; e.g., alerts. The alerts may be human generated or system generated. All of the alerts may be handled by a system; e.g., a monitoring system. The inventive approach replaces the static approach by a dynamic scheduling and assignment approach, which may reflect available, dynamically changing resources; e.g., endpoints or operators and different skills available. A waste of resources may be eliminated because the endpoints may be addressed in a more balanced way, which may increase operator morale and motivation and may lead to a learning environment in which unexperienced operators are also demanded. The inventive method may also be instrumental in not overburdening the most experienced operators because typically most alerts go to the most experienced operators first as default.

The present invention may also allow an easier fulfilment of service level agreements with limited resources because the service level agreements are assigned in the most effective way under given constraints, which is achieved by not only taking into account individual availabilities of individual operators but also dependencies among the operators. The concept of available or dynamic technical skill points enables achieving this assignment of service level agreements in the most effective way.

Additionally, the growing skills in a group of operators or service technicians may be reflected in a dynamic way. Furthermore, a smooth transition from one service shift to another service shift may be enabled in an elegant way, which may allow the departing shift to slow down the departing shift's support delivery whereas a coming shift of operators may gradually take over responsibility for newly incoming alerts. Overall, a human operator performing the scheduling manually may be eliminated altogether, which may also avoid biased assignment decisions.

The inventive method may also reflect that a specific operator may have skills in different technical areas or topic areas. The inventive system may be able to be adapted dynamically to a situation in which an operator may be faster in resolving an alert related issue than had been planned or anticipated.

As an additional effect, an operator relating to an endpoint may also be able to have a break in the operator's work by reducing the operator's available technical skill points to zero for the time of the operator's unavailability. Such an off-time of an operator can easily be handled by the dynamic assignment method.

Furthermore, the method may also be adapted to a case in which a resolution of an alert related problem solving takes longer than an anticipated time frame. The concept of technical skill points may build the basis for such a case, which adds another level of dynamic adaptability.

According to one embodiment of the method, increasing the available technical skill points may also comprise, in case of no waiting alerts at the point in time after an alert is closed, increasing the available technical skill points for the selected topic of the assignment endpoint to the topic dependent technical skill points from the operator's profile, which may guarantee that the resource or operator may be ready to accept the next alert and may enable a good, or the best, service the group of endpoint may provide to alert sending entities.

In one embodiment, the available technical skill points for the selected topic of the assignment endpoint may not be increased to an original level of skill points but may be increased to a value below a maximal level of available technical skill points, which may represent a reduction in assignment of alerts to the operator with the highest value of available technical skill points. Thus, after the operator with the highest value of originally assigned technical skill points and available technical skill points has solved a series of alerts, other members of the group may also be assigned alerts and thus may also gain experience. However, it may be noted that this scenario is related to a situation in which no other alerts are waiting and the complete group of endpoints may go to an idle status.

According to another embodiment of the inventive method, the method may comprise retrieving the topic dependent technical skill points from the individual operator profiles for the endpoints of the first group and assign the topic dependent available technical skill points to related endpoints, which may be performed at a beginning of a shift if none of the operators has been assigned alerts. It may also be valuable to calculate a sum of all topic dependent technical skill points for a given shift, which may allow estimating whether enough personnel may be available to handle the expected number of alerts during the shift. If the expected number of technical skill points for a given topic may not be sufficient, an escalation procedure may be initiated.

According to an embodiment of the inventive method, the first group of endpoints may be available for receiving alerts during a first time period; e.g., a first shift for the selected topic, and a second group of endpoints; e.g., a second or subsequent shift for the selected topic may be available for receiving alerts during a second time period. The first time period and the second time period may overlap during an overlap time period, which may allow a smooth transition of the responsibility of handling alerts from one shift to a next shift. The dynamic assignment of alerts may wind down responsibility and workloads of the leaving shift gradually and consequently increase the available technical skill point of the beginning shift gradually.

Thus, according to an additional embodiment of the inventive method, the number of available technical skill points for a topic of an endpoint of the first group may be decreased gradually (e.g., linearly) from a current value at a beginning of the overlap time period to zero at an end of the overlap time period. The first shift slowly fades away, while the next, fresh shift slowly takes over. No abrupt and hectic hand-over from one shift to another occurs. Instead a more relaxing hand-over procedure may be followed.

Consequently, according to a further embodiment of inventive method, the number of available technical skill points for a topic of an endpoint of the second group may be increased gradually (e.g., linearly) from zero at the beginning of the overlap time period to a number of available technical skill points according to the individually assigned topic dependent technical skill points of the related endpoint; i.e., operator. The increasing of the available technical skill point for the next shift may be mirrored by the decreasing number of technical skill points of the leaving shift.

In one embodiment, an operator is not able to resolve the alert related issue in a time being specified by the alert type. In one embodiment, once the pre-defined alert resolution time is reached without fixing the problem, the available technical skill point is again reduced to the predefined value (e.g., zero), and the expected resolution time value is increased by a predefined percentage. Afterwards, the available technical skill may be again increased gradually as discussed above. The same procedure may be repeated until the alert is resolved. Additionally, according to an additional embodiment, the pre-defined alert resolution time may be increased for an alert of the same type.

According to one embodiment of the inventive method, an alert may be specified by at least one of: a severity code, a group identifier, a component name (e.g., CloudFoundry-Router, CloudFoundry-UAA, DB2®, WebSphere®, CICS® (the last three component names being Trademarks of International Business Machines Corporation), mySQL), a component technical type, a component connection, a describing name, a component test suite, and a status. Moreover, the incoming alert may be assigned to an endpoint to which a comparable alert may have been assigned before. A comparable alert may, e.g., be an alert relating to the combination of component name and component type.

It may be noted that a technical type of the component or the component technical type may be related to an OSI reference model (Open Systems Interconnection model); e.g., network, hypervisor, application, user interface, etc. The component connection may describe dependencies to other components.

According to one embodiment of the inventive method, the alert may also be specified by a predefined alert resolution time may be a typical time required to fix the problem or perform the task related to the alert. This predefined alert resolution time may advantageously be used to calculate an increase in technical skill points over time during the predefined alert resolution time.

Furthermore, the predefined alert resolution time may be a base value for an operator with basic skills. Depending on the skill level of an operator, specified by the operator's profile, a weighting factor derived from the topic dependent technical skill points of an operator may be applied to the predefined alert resolution time, resulting in an assumed actual alert resolution time, which may reflect the real skills (also including general skills, see below) of an operator and may represent a further level of dynamism of the proposed method. Thus, a more experienced operator is expected to solve the same problem faster in comparison with a novice operator.

According to an embodiment of the inventive method, the topic dependent technical skill points for the selected topic may be increased after a predefined number of alerts relating to the selected topic have been closed by the endpoint, which may reflect the growing knowledge of an operator. It may be assumed that after a certain number of solved issues relating to alerts of the same type, the operator's skills may have been improved; i.e., the operator should have a better knowledge of the related subject-matter, which may be reflected in a dynamic increase in the operator's amount of technical skill points. Therefore, the advanced mechanism of the present invention may also reflect another level of dynamism of the underlying process of the inventive method.

Thus, it may be advantageous in one embodiment that an alert relating to the same topic may be assigned to the same operator unless, e.g., the operator already has a task to work on (i.e., the operator's available technical skill points are below the level of technical skill points of other operators).

According to an embodiment of the inventive method, the topic dependent technical skill points may be combined with general skill points, forming a combined skill point value. These combined skill points may also be referred to as static technical skill points. In the simpler case without general skill points, the topic dependent technical skill points may be denoted as static technical skill points. The combined skill point value may be used instead of the simpler topic dependent technical skill points. The general skill points may reflect general knowledge that may not be topic dependent (e.g., project management skills, a number of different topic areas that may be addressed, time of having been an operator, communication skills or other directly topic dependent skills).

According to one embodiment of the inventive method, increasing the available technical skill points for the selected topic of the assignment endpoint gradually over an alert resolution time may be performed immediately after an alert is closed by the endpoint, (i.e., after the operator may have finished the alert related task). An increase in available technical skill points may occur to the level of the technical skill points of the endpoints having the lowest number of technical skill points available. Thus, the endpoint (i.e., the operator) may be available for a next incoming alert and may not be forced to wait until the available technical skill points have been increased based on the alert resolution time.

In the following description of the figures, a block diagram of an embodiment of the inventive method for dynamically assigning alerts to endpoints is given, followed by embodiments of the system for dynamically assigning alerts to endpoints.

Performing an alert comprises performing the alert's task. Completing an alert comprises completing performance of the alert's task.

The present invention improves human resources technology, including improving an efficiency of completing a task and a quality of a result from completion of the task, by dynamically assigning alerts to endpoints for implementing performance of the task.

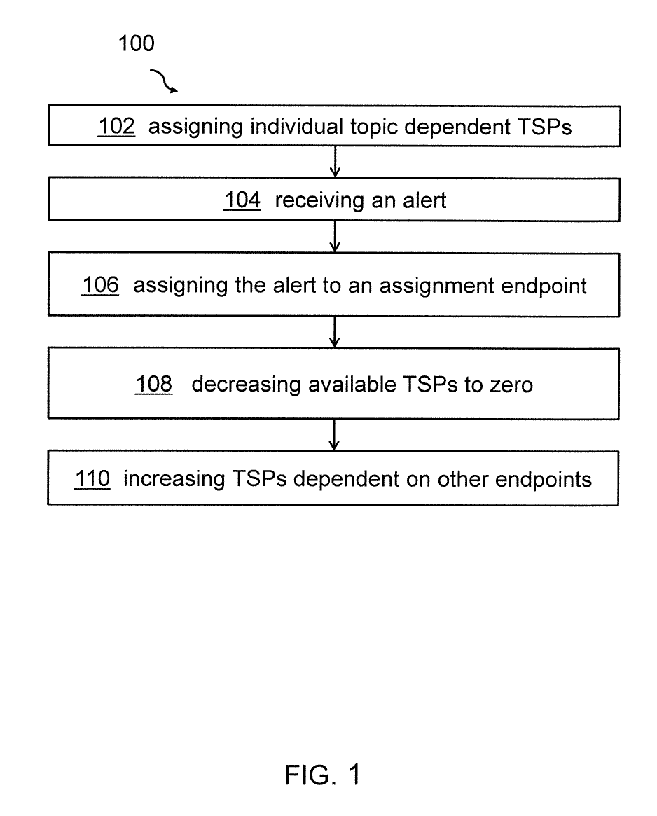

FIG. 1 shows a block diagram of a method 100 for dynamically assigning alerts to endpoints, in accordance with embodiments of the present invention. An endpoint may also be seen as a device relating to an operator, by which the operator may receive tasks or alerts to be solved. The method comprises assigning individually, step 102, topic dependent technical skill points (TSP) to each endpoint of a plurality of endpoints. The topic dependent technical skill points may be seen as a characteristic value of the endpoint, aka operator. This characteristic value of the endpoint may change based on skill automatic, semi-automatic or manual assessments. In one embodiment, the topic dependent technical skill points stay constant during a first or second time period; i.e., a first or second shift.

Each endpoint relates to an individual operator profile which may specify a plurality of topics; i.e., an operator may have different skills in different technical domains or topics. Examples topics may be database, portal, a specific application, a transaction system, etc. The skills of an operator, also known as service technician, may differ from topic to topic.

The method 100 also comprises receiving, step 104, an alert relating to a selected topic, and assigning, step 106, at an assignment time, the alert to an assignment endpoint having the highest number of available technical skill points for the selected topic, wherein the assignment endpoint is a member of a first group of endpoints relating to the selected topic. It may be noted that the first group may be a group of operators with skills in the same topic working in a first shift. It may be understood that an assignment endpoint may denote an endpoint to which an alert has been assigned.

Additionally, the method comprises decreasing, step 108, available technical skill points of the assignment endpoint for the selected topic to a predefined value, in particular zero, at the assignment time, and increasing, step 110, the available technical skill points for the selected topic of the assignment endpoint gradually over an alert resolution time from the predefined value to a number of technical skill points identical to a lowest number of technical skill points of endpoints out of the first group of endpoints relating to the selected topic.

If an endpoint has more than one skill area (i.e., technical skill points for more than one topic) and if an alert is assigned to the endpoint regarding a specific alert, the number of available technical skill points relating to the specific alert are dropped to zero. Because the operator relating to the endpoint is now busy working on the alert, also the available technical skill points of the other topics (i.e., skill areas) are dropped to zero.

FIGS. 2a, 2b, 2c, and 2d show block diagrams of examples of a development of available technical skill points over time with two endpoints A and B, in accordance with embodiments of the present invention. As shown in FIG. 2a, endpoint or operator A has 6 available technical skill points, whereas operator B has 2 available technical skill points. It may now be assumed that an alert is coming in which is assigned to operator A. The number of available technical skill points will be dropped from 6 to 0 at the moment of the assignment (i.e., the assignment time) as shown in FIG. 2b. Because operator B does not have any assigned alerts, operator B's number of available technical skill points remains at 2.

Based on a predefined alert resolution time related to the type of alert, the number of available technical skill points of operator A may be increased again as shown in FIG. 2c. It may be assumed that no additional alerts are coming in waiting to be assigned to an operator. In this case, after the task related to the alert being assigned to operator A has been performed and the alert has been closed, the number of available technical skill points will be increased immediately to the original value of 6 as shown in FIG. 2d.

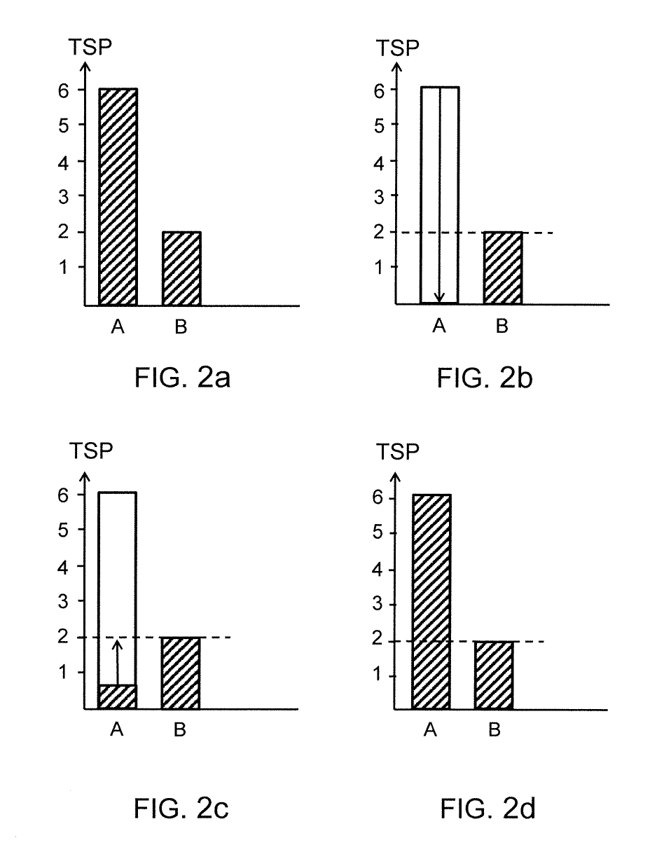

FIGS. 3a, 3b, 3c and 3d show block diagrams of a development of available technical skill points over time with more endpoints and more complex dependencies, in accordance with embodiments of the present invention. FIGS. 3a, 3b, 3c, and 3d show 5 operators A, B, C, D and E. Operator A has 6 available technical skill points, operators B and C each have 4 available technical skill points, and operators D and E each have 2 available technical skill points. It may be assumed that the 5 operators A, B, C, D, E form a group relating to a topic.

Next, an alert is coming in and the alert is assigned to operator A. Operator A's available technical skill points drop immediately to 0 as shown in FIG. 3b. As in the example of FIG. 2c, an increase of the number of technical skill points of operator A is based on the predefined alert resolution time as well as the number of available technical skill points of the operator having the lowest number of topic dependent technical skill points. In this case, this number (of available technical skill points of the operator having the lowest number of topic dependent technical skill poin) is 2 because of operators D and E, as shown in FIG. 3c.

FIG. 3d shows that the additional alerts have come in and are assigned to operators B, C, and D. The available technical skill points of operator B has been decreased because of the alert assignment to operator B, whereas the number of available technical skill points of operators C and D have been reduced to a value close to 0, because of the alerts that have just been assigned to operators C and D. It may also be noted, that the number of available technical skill points of operator A has only been increased to the maximum number of available technical skill points of operator D because other alerts are being worked on by operator A.

It may also be noted that the potential number of available technical skill points for operator E is set to 0, which may be done, in one embodiment, if the operator E has a status set to inactive; e.g. operator E may not be available for the group for a certain (known or unknown) amount of time. Operator E may take a break or may not be available for other reasons. In this case, no incoming alerts would be assigned to operator E. Operator E can only receive alerts again if operator E's status is set to active again. The thin solid black rectangle 55 at operator E in FIG. 3d (which is visually distinguished from the diagonal hatch pattern 66 for operators A, B, C and D) does not denote the number of available technical skill points of operators E, but rather denotes that operator E has an inactive status with no available technical skill points.

The described method demonstrates typical cases of a self-adjustment of incoming alerts to a group of operators. As has been demonstrated, the method is dynamic according to different aspects. The number of topic dependent technical skill points of the profile of an endpoint (i.e., an operator) may be self-adjusting, as well is the number of available technical skill points during a time interval (e.g., a shift) during which an operator is working together with other operators as a group for a specific topic.

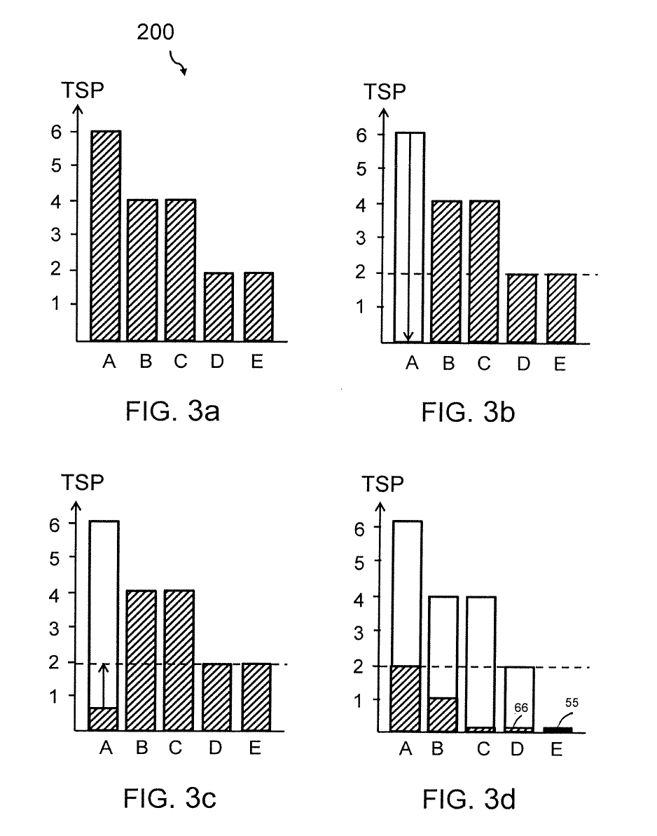

FIG. 4 shows a shift overlap period and an increasing and a decreasing of available technical skill points of a leaving shift and a beginning shift, respectively, in accordance with embodiments of the present invention. The horizontal axis represents the time. Symbols s₁, s₂ and s₃ represent different shifts. For example, shift s₁ ends at 8:00, whereas shift s₂ starts at 7:00 and ends at 16:00. Thus, there is an overlap time period t_{O1} (between shifts s₁ and s₂) of one hour from 7:00 to 8:00. Similarly, there is a time overlap period t_{O2} from 15:00 to 16:00 between shift s₂ and shift s₃. The next overlap time period t_{O3} is positioned between shift s₃ and the next shift. It may be noted that the sum of available technical skill points (Σ TSP) of all shifts is constant in the example of FIG. 4, which may not occur generally, because shifts may have different numbers of available operators and/or the number of available technical skill points may be different from shift to shift.

A shift may have a different sum of technical skill points per group reflecting time periods of lower alert activity, which may be seen as an additional aspect of the dynamicity of the alert assignments.

As can also be seen from FIG. 4, the sum of available technical skill points of shift s₁ may be decreased gradually during the time overlap period t_{O1}. Typically, a decreasing number of available technical skill points may be calculated for each operator individually. It may also be noted that the time overlap period of 1 h may only be an example. Other time overlap periods are possible. Additionally, the time overlap periods between any two subsequent shifts may be different.

In parallel to the decreasing of the available technical skill points of a leaving shift (e.g., shift s₁), the number of available technical skill points for a next shift (e.g., shift s₂), may be increased gradually. Again, typically, this change of the available technical skill points may be performed on an operator by operator basis which leaves room for a smooth transition from the leaving shift to the next shift. During the time overlap period, alerts may be assigned to members of the first group and the second group, representing a first shift and a second shift, simultaneously.

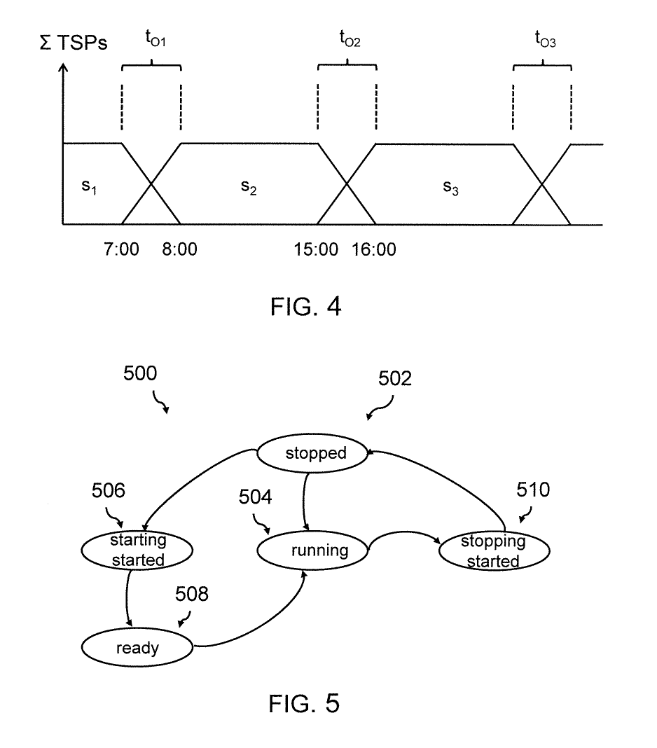

FIG. 5 shows a state diagram 500 of a group of endpoints in a shift, in accordance with embodiments of the present invention. Status 502 represents a “stopped” shift. The available technical skill points are set to 0 and no alerts can be assigned to any of the operators of the group. In status “running” 504, the available technical skill points for each operator in the group is set initially to the maximum number of available technical skill points; i.e., the topic dependent technical skill points of each of the profiles of the related endpoints of the group. In this status “running” 504, alerts may be assigned to individual operators of the group.

In the status “ready” 508, the available technical skill points of the operators are also set to 0. No alerts are assigned to the operators of the group in this status “ready” 508; and the group of operators is awaiting a shift handover time period; i.e., the time overlap period. In status 506 “start initiated”, the amount of available technical skill points is increasing from 0 to the number of technical skill points of the related operator profiles.

In contrast, in the status “stop starting” 510, the amount of available technical skill points is decreasing in preparation for the end of the shift during the related time overlap period. It may be noted that each of the operators of the shift (i.e., a group) may have these different statuses shown in FIG. 5.

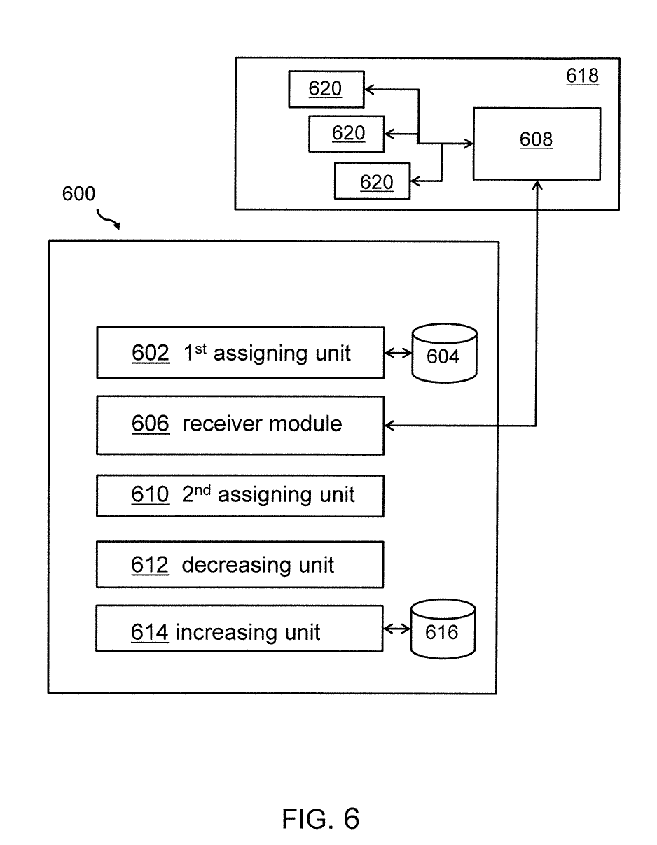

FIG. 6 shows a system for dynamically assigning alerts to endpoints, in accordance with embodiments of the present invention. The system in FIG. 6 comprises a first assigning unit 602 adapted for assigning individually topic dependent technical skill points to each endpoint of a plurality of endpoints. Each endpoint relates to an individual operator profile which may be stored in a persistent storage 604. Each endpoint profile (i.e., operator profile) may optionally specify not only one topic for an endpoint (i.e., an operator), but also a plurality of different topics, meaning that an operator may be assigned alerts of different technical fields. However, the number of technical skill points may be different from topic to topic for a same endpoint.

Additionally, the system comprises a receiver module 606 adapted for receiving an alert relating to a selected topic. The alert may come from a monitoring system 608 belonging to a data processing environment 618. The monitoring system 608 may be configured to monitor different components 620 of the data processing environment 618. Alternatively, alerts may come in via telephone or other electronic messaging systems.

Furthermore, the system comprises also a second assigning unit 610 adapted for assigning, at an assignment time, the alert to an assignment endpoint having a highest number of available technical skill points for the selected topic. The assignment endpoint is a member of a first group (e.g., 1^{st} shift) of endpoints relating to the selected topic.

Moreover, the system comprises a decreasing unit 612 adapted for decreasing available technical skill points of the assignment endpoint for the selected topic to a predefined value (e.g., zero) at the assignment time as explained above referring to FIGS. 2 and 3.

The system comprises an increasing unit 614 adapted for increasing the available technical skill points for the selected topic of the assignment endpoint gradually over an alert resolution time from the predefined value to a number of technical skill points identical to a lowest number of technical skill points of endpoints out of the first group of endpoints relating to the selected topic. Specifics about this increasing the available technical skill points has already been explained in the context of FIGS. 3a-3d. The predefined alert resolution time may be retrieved from a persistent storage 616.

It may also be noted that, in one embodiment, the predefined alert resolution time may dynamically be adapted on a regular basis if operators have been able to resolve the problem related to an alert in a shorter time period than an originally predefined alert resolution time.

Embodiments of the invention may be implemented together with virtually any type of computer, regardless of the platform being suitable for storing and/or executing program code.

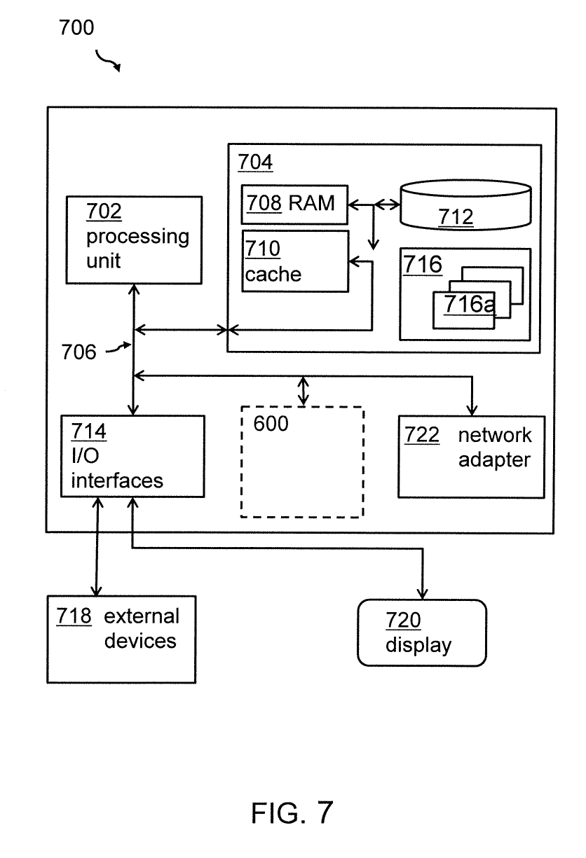

FIG. 7 shows a computer system 700 for dynamically assigning alerts to endpoints, in accordance with embodiments of the present invention.

The computer system 700 is only one example of a suitable computer system and is not intended to suggest any limitation as to the scope of use or functionality of embodiments of the invention described herein. Regardless, computer system 700 is capable of being implemented and/or performing any of the functionality set forth hereinabove. In the computer system 700, there are components, which are operational with numerous other general purpose or special purpose computing system environments or configurations. Examples of well-known computing systems, environments, and/or configurations that may be suitable for use with computer system/server 700 include, but are not limited to, personal computer systems, server computer systems, thin clients, thick clients, hand-held or laptop devices, multiprocessor systems, microprocessor-based systems, set top boxes, programmable consumer electronics, network PCs, minicomputer systems, mainframe computer systems, and distributed cloud computing environments that include any of the above systems or devices, and the like. Computer system/server 700 may be described in the general context of computer system-executable instructions, such as program modules, being executed by a computer system 700. Generally, program modules may include routines, programs, objects, components, logic, data structures, and so on that perform particular tasks or implement particular abstract data types. Computer system/server 700 may be practiced in distributed cloud computing environments where tasks are performed by remote processing devices that are linked through a communications network. In a distributed cloud computing environment, program modules may be located in both local and remote computer system storage media including memory storage devices.

As shown in the figure, computer system/server 700 is shown in the form of a general-purpose computing device. The components of computer system/server 700 may include, but are not limited to, one or more processors or processing units 702, a system memory 704, and a bus 706 that couples various system components including system memory 704 to the processor 702. Bus 706 represents one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnects (PCI) bus. Computer system/server 700 typically includes a variety of computer system readable media. Such media may be any available media that is accessible by computer system/server 700, and it includes both, volatile and non-volatile media, removable and non-removable media.

The system memory 704 may include computer system readable media in the form of volatile memory, such as random access memory (RAM) 708 and/or cache memory 710. Computer system/server 700 may further include other removable/non-removable, volatile/non-volatile computer system storage media. By way of example only, storage system 712 may be provided for reading from and writing to a non-removable, non-volatile magnetic media (not shown and typically called a ‘hard drive’). Although not shown, a magnetic disk drive for reading from and writing to a removable, non-volatile magnetic disk (e.g., a ‘floppy disk’), and an optical disk drive for reading from or writing to a removable, non-volatile optical disk such as a CD-ROM, DVD-ROM or other optical media may be provided. In such instances, each can be connected to bus 706 by one or more data media interfaces. As will be further depicted and described below, memory 704 may include at least one program product having a set (e.g., at least one) of program modules that are configured to carry out the functions of embodiments of the invention.

Program/utility 714, having a set (at least one) of program modules 716, may be stored in memory 704 by way of example, and not limitation, as well as an operating system, one or more application programs, other program modules, and program data. Each of the operating system, one or more application programs, other program modules, and program data or some combination thereof, may include an implementation of a networking environment. Program modules 716 generally carry out the functions and/or methodologies of embodiments of the invention as described herein.

The computer system/server 700 may also communicate with one or more external devices 718 such as a keyboard, a pointing device, a display 720, etc.; one or more devices that enable a user to interact with computer system/server 700; and/or any devices (e.g., network card, modem, etc.) that enable computer system/server 700 to communicate with one or more other computing devices. Such communication can occur via Input/Output (I/O) interfaces 714. Still yet, computer system/server 700 may communicate with one or more networks such as a local area network (LAN), a general wide area network (WAN), and/or a public network (e.g., the Internet) via network adapter 722. As depicted, network adapter 722 may communicate with the other components of computer system/server 700 via bus 706. It should be understood that although not shown, other hardware and/or software components could be used in conjunction with computer system/server 700. Examples, include, but are not limited to: microcode, device drivers, redundant processing units, external disk drive arrays, RAID systems, tape drives, and data archival storage systems, etc.

Additionally, the system 600 for dynamically assigning alerts to endpoints may be attached to the bus system 706.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, Firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

A computer program product of the present invention includes one or more computer readable hardware storage devices having computer readable program code stored therein, said program code containing instructions executable by one or more processors of a computing system (or computer system) to implement the methods of the present invention.

A computing system (or computer system) of the present invention includes one or more processors, one or more memories, and one or more computer readable hardware storage devices, said one or more hardware storage devices containing program code executable by the one or more processors via the one or more memories to implement the methods of the present invention.

The terminology used herein is for the purpose of describing particular embodiments only and is not intended to limit the invention. As used herein, the singular forms “a”, “an” and “the” are intended to include the plural forms as well, unless the context clearly indicates otherwise. It will further be understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or steps plus function elements in the claims below are intended to include any structure, material, or act for performing the function in combination with other claimed elements, as specifically claimed. The description of the present invention has been presented for purposes of illustration and description, but is not intended to be exhaustive or limited to the invention in the form disclosed. Many modifications and variations will be apparent to those of ordinary skills in the art without departing from the scope and spirit of the invention. The embodiments are chosen and described in order to best explain the principles of the invention and the practical application, and to enable others of ordinary skills in the art to understand the invention for various embodiments with various modifications, as are suited to the particular use contemplated.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others or ordinary skill in the art to understand the embodiments disclosed herein.

What is claimed is:

1. A method for dynamically assigning alerts to endpoints, said method comprising:
assigning, by one or more processors of a computer system, individually topic dependent technical skill points to each endpoint of a plurality of endpoints;
said one or more processors receiving an alert for a task relating to a selected topic; and
in response to said receiving the alert,
(i) said one or more processors assigning the received alert to an assignment endpoint having a highest number of available technical skill points for the selected topic, wherein the assignment endpoint is a member of a first group of endpoints relating to the selected topic, and wherein the plurality of endpoints comprises the first group of endpoints,
(ii) said one or more processors decreasing available technical skill points of the assignment endpoint to a predefined value, and
(iii) said one or more processors increasing the available technical skill points for the assignment endpoint gradually over an alert resolution time from the predefined value to a number of technical skill points identical to a lowest number of technical skill points of endpoints of any member of the first group of endpoints.

2. The method of claim 1, wherein no new alert exists at a time at which the alert is closed, and wherein said increasing the available technical skill points comprises:
increasing the available technical skill points for the selected topic of the assignment endpoint to the topic dependent technical skill points from an operator profile of the assignment endpoint.

3. The method of claim 1, said method further comprising:
said one or more processors retrieving the topic dependent technical skill points from the individual operator profiles for the endpoints of the first group and assigning the topic dependent available technical skill points to related endpoints.

4. The method of claim 1, wherein the first group of endpoints is available for receiving alerts during a first time period for the selected topic, wherein a second group of endpoints for the selected topic is available for receiving alerts during a second time period, and wherein the first time period and the second time period partially overlap during an overlap time period.

5. The method of claim 4, wherein the number of available technical skill points for a topic of one endpoint of the first group is decreased gradually from a value at a beginning of the overlap time period to zero at an end of the overlap time period.

6. The method of claim 4, wherein the number of available technical skill points for a topic of one endpoint of the second group is increased gradually from zero at the beginning of the overlap time period to a number of available technical skill points according to the individually assigned topic dependent technical skill points.

7. The method of claim 1, wherein the alert is specified by at least one of: a severity code, a group identifier, a component name, a component technical type, a component connection, a describing name, a component test suite, and a status, and wherein the alert is assigned to an endpoint to which a comparable alert has been assigned before.

8. The method of claim 7, wherein the alert is additionally specified by a predefined alert resolution time.

9. The method of claim 1, wherein the topic dependent technical skill points for the selected topic are increased after a predefined number of alerts relating to the selected topic has been closed by said the assignment endpoint.

10. The method of claim 1, wherein the topic dependent technical skill points are combined with general skill points to form a combined skill point value.

11. The method of claim 1, wherein said increasing the available technical skill points for the selected topic of the assignment endpoint gradually over an alert resolution time is performed immediately after the alert is closed by the assignment endpoint.

12. A computer program product, comprising one or more computer readable hardware storage devices having computer readable program code stored therein, said program code containing instructions executable by one or more processors of a computer system to implement a method for dynamically assigning alerts to endpoints, said method comprising:
said one or more processors assigning individually topic dependent technical skill points to each endpoint of a plurality of endpoints;
said one or more processors receiving an alert for a task relating to a selected topic; and
in response to said receiving the alert, said one or more processors: (i) assigning the received alert to an assignment endpoint having a highest number of available technical skill points for the selected topic, wherein the assignment endpoint is a member of a first group of endpoints relating to the selected topic, and wherein the plurality of endpoints comprises the first group of endpoints, (ii) decreasing available technical skill points of the assignment endpoint to a predefined value, and (iii) increasing the available technical skill points for the assignment endpoint gradually over an alert resolution time from the predefined value to a number of technical skill points identical to a lowest number of technical skill points of endpoints of any member of the first group of endpoints.

13. The computer program product of claim 12, wherein no new alert exists at a time at which the alert is closed, and wherein said increasing the available technical skill points comprises:
increasing the available technical skill points for the selected topic of the assignment endpoint to the topic dependent technical skill points from an operator profile of the assignment endpoint.

14. The computer program product of claim 12, said method further comprising:
said one or more processors retrieving the topic dependent technical skill points from the individual operator profiles for the endpoints of the first group and assigning the topic dependent available technical skill points to related endpoints.

15. The computer program product of claim 12, wherein the first group of endpoints is available for receiving alerts during a first time period for the selected topic, wherein a second group of endpoints for the selected topic is available for receiving alerts during a second time period, and wherein the first time period and the second time period partially overlap during an overlap time period.

16. The computer program product of claim 15, wherein the number of available technical skill points for a topic of one endpoint of the first group is decreased gradually from a value at a beginning of the overlap time period to zero at an end of the overlap time period.

17. A computer system, comprising one or more processors, one or more memories, and one or more computer readable hardware storage devices, said one or more hardware storage device containing program code executable by the one or more processors via the one or more memories to implement a method for dynamically assigning alerts to endpoints, said method comprising:
said one or more processors assigning individually topic dependent technical skill points to each endpoint of a plurality of endpoints;
said one or more processors receiving an alert for a task relating to a selected topic; and
in response to said receiving the alert,
(i) said one or more processors assigning the received alert to an assignment endpoint having a highest number of available technical skill points for the selected topic, wherein the assignment endpoint is a member of a first group of endpoints relating to the selected topic, and wherein the plurality of endpoints comprises the first group of endpoints,
(ii) said one or more processors decreasing available technical skill points of the assignment endpoint to a predefined value, and
(iii) said one or more processors increasing the available technical skill points for the assignment endpoint gradually over an alert resolution time from the predefined value to a number of technical skill points identical to a lowest number of technical skill points of endpoints of any member of the first group of endpoints.

18. The computer system of claim 17, wherein no new alert exists at a time at which the alert is closed, and wherein said increasing the available technical skill points comprises:
increasing the available technical skill points for the selected topic of the assignment endpoint to the topic dependent technical skill points from an operator profile of the assignment endpoint.

19. The computer system of claim 17, said method further comprising:
said one or more processors retrieving the topic dependent technical skill points from the individual operator profiles for the endpoints of the first group and assigning the topic dependent available technical skill points to related endpoints.

20. The computer system of claim 17, wherein the first group of endpoints is available for receiving alerts during a first time period for the selected topic, wherein a second group of endpoints for the selected topic is available for receiving alerts during a second time period, and wherein the first time period and the second time period partially overlap during an overlap time period.
